(19) United States
(12) Patent Application Publication
(10) Pub. No.: US 2014/0295325 A1
(43) Pub. Date: Oct. 2, 2014

(54) SELF-ASSEMBLY PLATINUM NANOSTRUCTURE WITH THREE DIMENSIONAL NETWORK STRUCTURE AND METHOD OF PREPARING THE SAME

(71) Applicant: Intellectual Discovery Co., Ltd., Seoul (KR)

(72) Inventors: Kwangyeol LEE, Seoul (KR); Jongsik PARK, Seoul (KR); Seyoung KOO, Seoul (KR)

(73) Assignee: INTELLECTUAL DISCOVERY CO., LTD., Seoul (KR)

(21) Appl. No.: 14/227,473

(22) Filed: Mar. 27, 2014

(30) Foreign Application Priority Data
Mar. 28, 2013 (KR) 10-2013-0033833

(51) Int. Cl. H01M 4/86; H01M 4/88; H01M 4/92

(52) U.S. Cl. CPC H01M 4/8626; H01M 4/8621; H01M 4/92; H01M 4/923; H01M 4/8875
USPC 429/524; 502/339

(57) ABSTRACT

A self-assembly platinum nanostructure with a three dimensional network structure contains a plurality of platinum nanoparticles having a cubic shape, wherein the plurality of platinum nanoparticles gather to form a cubic shape and are disposed in a {111} direction.

### CROSS-REFERENCE TO RELATED APPLICATION

This application claims priority to and the benefit of Korean Patent Application No. 10-2013-0033833 filed in the Korean Intellectual Property Office on Mar. 28, 2013, the entire contents of which are incorporated herein by reference.

### BACKGROUND

(a) Field

A self-assembly platinum nanostructure with a three dimensional network structure and a method of preparing the same are provided.

(b) Description of Related Art

Platinum has been used as a catalyst of an oxygen reduction reaction in a fuel cell, but an expensive cost of platinum becomes an obstacle to commercializing the fuel cell. Therefore, researches for improving characteristics of a catalyst in addition to decreasing a cost of the catalyst have been conducted, and among them, research into synthesis of platinum based nanoparticles of which catalytic characteristics such as reactivity, selectivity, or the like, are maximized has been significantly spotlighted.

Platinum nanoparticles having a three dimensional arrangement were formed through recrystallization of platinum nanoparticles synthesized in advance using a solvent having two different phases (J. Am. Chem. Soc. 2013. dx.doi.org/10.1021/ja3116839). However, in this method, since a synthesis reaction is composed of several steps, synthesis may be difficult.

In addition, nanoparticles having two kinds of three dimensional structures, in other words, spherical shaped and cubic shaped structures were formed using iron oxide. To this end, micelles formation was induced using two phases that were not mixed with each other (J. Am. Chem. Soc. 2012, 134, 18225). However, since this structure is formed only in the case of oxides rather than a noble metal, it may be difficult to apply this structure to the noble metal.

The above information disclosed in this Background section is only for enhancement of understanding of the background of the invention and therefore it may contain information that does not form the prior art that is already known in this country to a person of ordinary skill in the art.

### SUMMARY

In an embodiment, a self-assembly platinum nanostructure having a new structure under new synthetic conditions is provided.

In an embodiment, a self-assembly platinum nanostructure capable of improving characteristics of a platinum based catalyst is provided.

According to an exemplary embodiment, surface characteristics are controlled, such that a platinum nanostructure having a three dimensional cluster shape may be formed, and a high catalytic activity may be implemented.

According to an exemplary embodiment, a self-assembled nanostructure in which nanoparticles formed in situ by a specific reaction condition have a three dimensional arrangement may be formed without a recrystallization step.

In addition, according to an exemplary embodiment, a surface area may be further maximized by changing a three dimensional nanostructure self-assembled by a specific reaction condition into a new three dimensional network structure.

Further, according to an exemplary embodiment, a cost of a platinum catalyst may be adjusted by maximizing a surface area of nanostructure simultaneously with selectively exposing a specific surface of the nanostructure. An exemplary embodiment provides a self-assembly platinum nanostructure with a three dimensional network structure containing a plurality of platinum nanoparticles having a cubic shape, wherein the plurality of platinum nanoparticles gather to form a cubic shape and are disposed in a {111} direction.

An arrangement interval of the plurality of platinum nanoparticles disposed in the {111} direction may be narrower than that of the plurality of platinum nanoparticles disposed in a horizontal or vertical direction.

The plurality of platinum nanoparticles may be connected to each other by a surfactant.

An exemplary embodiment provides a method of preparing a self-assembly platinum nanostructure with a three dimensional network structure including pyrolyzing a platinum precursor, alkylamine, and alkylcarboxylic acid in a solvent, cooling the pyrolyzed solution to room temperature and separating the resultant to prepare a self-assembly platinum nanostructure, and putting the self-assembly platinum nanostructure in acetic acid and ethanol.

A content ratio of the platinum precursor, the alkylamine, and the alkylcarboxylic acid may be approximately x:4:1, wherein x may be approximately 0.001 or less.

A content ratio of the acetic acid and the ethanol may be approximately 200 μL to 800 μL:10 mL.

The pyrolyzing may be performed at about 150 to 200 degrees Celsius.

The pyrolysis may be performed under reducing gas atmosphere.

According to an exemplary embodiment, a self-assembly platinum nanostructure with a new structure under new synthetic conditions may be prepared, and characteristics of a platinum based catalyst may be improved.

### BRIEF DESCRIPTION OF THE DRAWINGS

FIG. 1 is a schematic view showing a method of deforming a self-assembly platinum nanostructure into a self-assembly platinum nanostructure with a new three dimensional network structure according to an exemplary embodiment of the present invention.

FIGS. 2 and 3 are transmission electron microscope (TEM) photographs of the self-assembly platinum nanostructure according to an exemplary embodiment of the present invention.

FIGS. 4 and 5 are TEM photographs of a self-assembly platinum nanostructure with a three dimensional network structure deformed according to an exemplary embodiment of the present invention.

FIG. 6 is a TEM photograph obtained by enlarging part A of FIG. 5.

FIG. 7 is an X-ray diffraction (XRD) graph of the self-assembly platinum nanostructure with a three dimensional network structure deformed according to an exemplary embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In addition, the detailed description of the widely known technologies will be omitted.

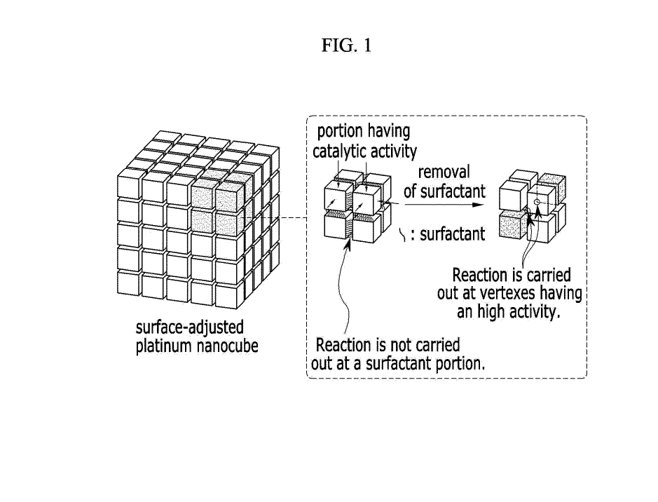

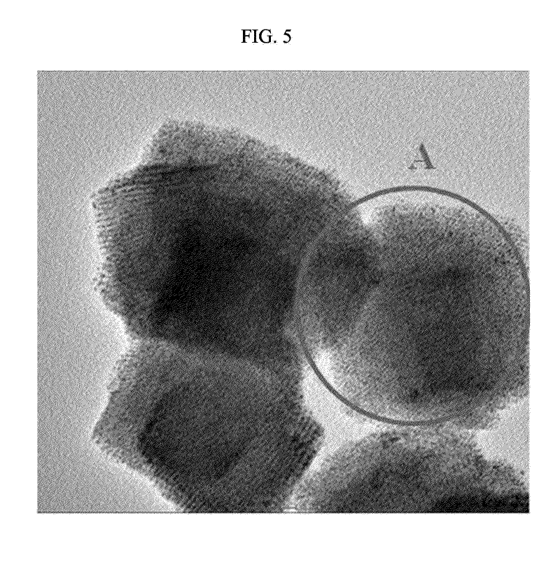

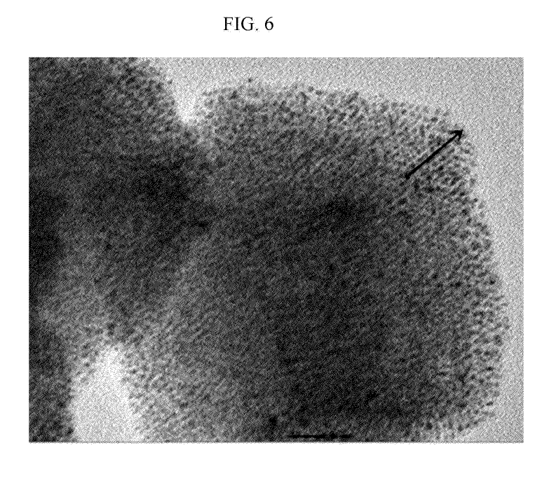

Hereinafter, a self-assembly platinum nanostructure according to an exemplary embodiment of the present invention will be described in detail with reference to FIGS. 1 to 7.

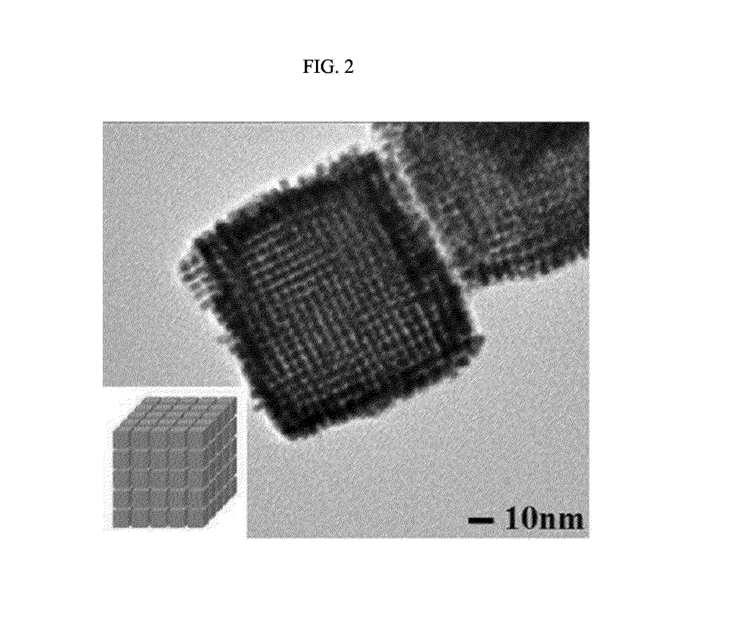

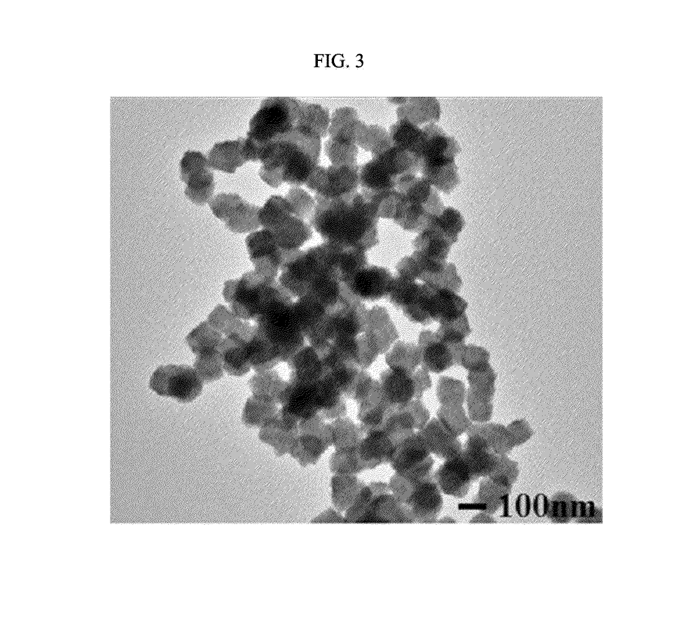

FIG. 1 is a schematic view showing a method of deforming a self-assembly platinum nanostructure into a self-assembly platinum nanostructure with a new three dimensional network structure according to an exemplary embodiment of the present invention, and FIGS. 2 and 3 are transmission electron microscope (TEM) photographs of the self-assembly platinum nanostructure according to an exemplary embodiment of the present invention.

Referring to FIGS. 1 to 3, the self-assembly platinum nanostructure has an approximately cubic shape and a size of about 100 nm, and this nanostructure is composed of a plurality of nanoparticles having a size of about 2 to 3 nm and a roughly cubic shape. The self-assembly platinum nanostructure may have a cluster structure. The plurality of nanoparticles configuring the self-assembly platinum nanostructure are connected to each other by a surfactant.

Since the platinum nanoparticles having the cubic shape is composed of {100} surfaces, in the self-assembly platinum nanostructure, {100} surfaces may be maximized.

Referring to FIGS. 1 and 4 to 6, the self-assembly platinum nanostructure with the three dimensional network structure has a structure in which a structural change is generated in the self-assembly platinum nanostructure.

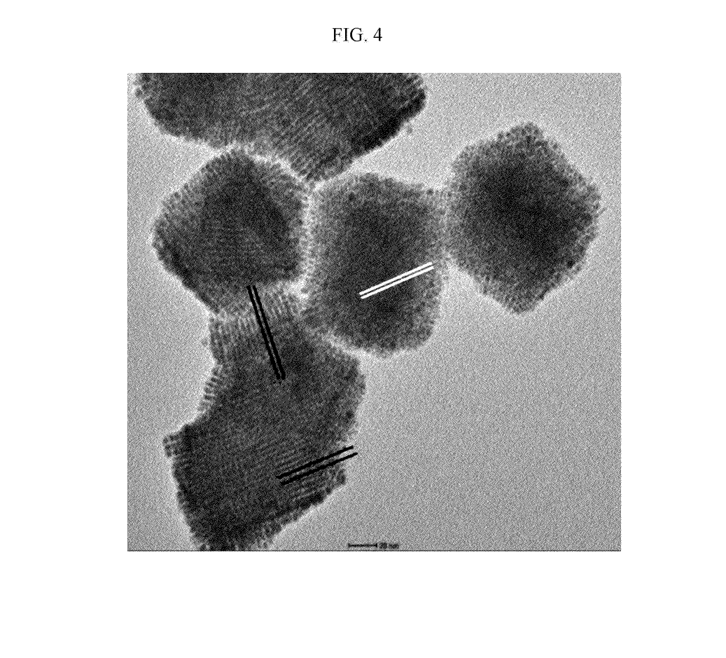

In the self-assembly platinum nanostructure with the three dimensional network structure, a vertex portion of the nanoparticle has a highest activity. Referring to FIGS. 1 and 4 to 6, a vertex of the nanoparticle may be disposed in a {111} direction. In the case of removing the surfactant, a distance between the nanoparticles is decreased, and junction between nanoparticles is induced at the vertex at which the activity is high, such that a self-assembly platinum nanostructure with a three dimensional network structure of which a surface area is maximized may be formed. Here, the surfactant connecting the nanoparticles may not be partially removed. For example, referring to FIG. 4, it may be appreciated that an interval between yellow lines indicating an arrangement interval of nanoparticles disposed in a diagonal {111} direction is narrower than an interval between red lines indicating an arrangement interval of nanoparticles disposed in a vertical direction and a horizontal direction. In the self-assembly platinum nanostructure with a three dimensional network structure, a catalytic activity may be maximized due to the nanoparticles disposed in the {111} direction.

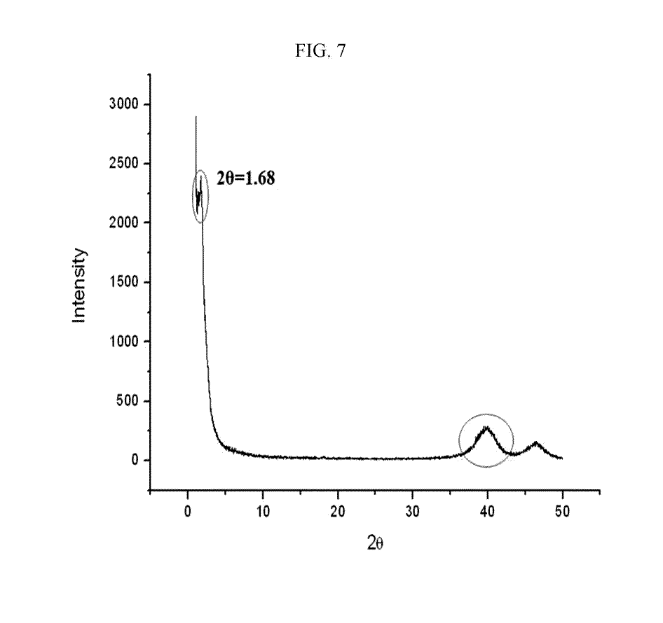

FIG. 7 is an X-ray diffraction (XRD) graph of the self-assembly platinum nanostructure with a three dimensional network structure deformed according to an exemplary embodiment of the present disclosure.

Referring to FIG. 7, a peak represented by a red circle is a basic peak indicating platinum. Since a peak at 2θ=about 1.68 is a low angle peak, it may be appreciated that the synthesized nanostructure with a three dimensional network structure has a cubic structure, which is a high ordered structure.

Hereinafter, a method of preparing a self-assembly platinum nanostructure with a three dimensional network structure according to an exemplary embodiment of the present invention will be described in detail.

First, in the method of preparing a self-assembly platinum nanostructure, a process of pyrolyzing a platinum precursor, alkylamine, and alkylcarboxylic acid in a solvent is performed. A content ratio of the platinum precursor, alkylamine, and alkylcarboxylic acid may be approximately X:4:1. X may be 0.001 or less. The reason is that alkylamine and alkylcarboxylic acid may be used as solvents. A pyrolysis reaction may be performed at approximately 150 to 200 degrees Celsius. The reaction may be performed under reducing gas atmosphere such as CO.

For example, as the platinum precursor, platinum acetylacetonate, or the like, may be used, as alkylamine (RNH₂) used as the surfactant, oleylamine, octadecylamine, or the like, may be used, as alkylcarboxylic acid (RCOOH), oleic acid, stearic acid, palmitic acid, or the like, may be used, and as the solvent, alkylamine and alkylcarboxylic acid may be used.

In addition, the pyrolysis reaction may be performed in a schlenk tube, round-bottom flask including a bubbler connected thereto, or the like.

After the pyrolysis reaction, a self-assembly platinum nanostructure may be obtained by cooling the pyrolyzed solution to room temperature and then separating the resultant. For example, centrifugation may be used. The prepared self-assembly platinum nanostructure may be washed using toluene, methanol, or the like and then dried.

Next, a process of putting the self-assembly platinum nanostructure into acetic acid and ethanol to remove the surfactant in a surface of the nanostructure is performed. For example, a ratio of acetic acid and ethanol may be approximately 200 μL-800 μL:10 mL.

The method of preparing a self-assembly platinum nanostructure with a three dimensional network structure according to an exemplary embodiment may be performed by a simple process and be advantageous in mass-production.

Hereinafter, the present invention will be described in detail with reference to Examples, but the following Examples are only examples of the present invention, and the present invention is not limited to the following Examples.

### Preparation of Self-Assembly Platinum Nanostructure

A process of reacting platinum acetylacetonate (about 0.012 mmol), oleylamine (about 15 mmol), and oleic acid (3.75 mmol) solutions for about 30 minutes in an oil bath heated to about 180 degrees Celsius while magnetic stirring and blowing CO was performed. Therefore a self-assembly platinum nanostructure was prepared, and TEM photographs of the prepared self-assembly platinum nanostructure are shown in FIGS. 2 and 3.

### Preparation of Self-Assembly Platinum Nanostructure with Three Dimensional Network Structure

A process of drying the prepared self-assembly platinum nanostructure, putting about 3 mg of the obtained self-assembly platinum nanostructure into a vial and adding acetic acid and ethanol at a ratio of about 500 μL:10 mL was performed. Therefore, a self-assembly platinum nanostructure with a three dimensional network structure was prepared. TEM photographs of the prepared self-assembly platinum nanostructure with a three dimensional network structure are shown in FIGS. 4 to 6, and an XRD graph thereof is shown in FIG. 7.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A self-assembly platinum nanostructure with a three dimensional network structure comprising a plurality of platinum nanoparticles having a cubic shape, wherein the plurality of platinum nanoparticles gather to form a cubic shape and are disposed in a {111} direction.

2. The self-assembly platinum nanostructure with a three dimensional network structure of claim 1, wherein:
an arrangement interval of the plurality of platinum nanoparticles disposed in the {111} direction is narrower than an arrangement interval of the plurality of platinum nanoparticles disposed in a horizontal or vertical direction.

3. The self-assembly platinum nanostructure with a three dimensional network structure of claim 2, wherein:
the plurality of platinum nanoparticles configuring the self-assembly platinum nanostructure are connected to each other by a surfactant.

4. A method of preparing a self-assembly platinum nanostructure with a three dimensional network structure, the method comprising:
pyrolyzing a platinum precursor, alkylamine, and alkylcarboxylic acid in a solvent to form a solution;
cooling the solution to room temperature and separating the solution to prepare a self-assembly platinum nanostructure; and
putting the self-assembly platinum nanostructure in acetic acid and ethanol.

5. The method of claim 4, wherein:
a content ratio of the platinum precursor, the alkylamine, and the alkylcarboxylic acid is x:4:1, x being 0.001 or less.

6. The method of claim 4, wherein:
a content ratio of the acetic acid and the ethanol is 200 μL to 800 μL:10 mL.

7. The method of claim 4, wherein:
the pyrolysis is performed at 150 to 200 degrees Celsius.

8. The method of claim 4, wherein:
the pyrolysis is performed under reducing gas atmosphere.
